(19) United States
(12) Patent Application Publication
(10) Pub. No.: US 2026/0182727 A1
(43) Pub. Date: Jul. 2, 2026

(54) METHODS AND SYSTEMS FOR HAIR VIRTUAL TRY-ONS (VTOs) USING GENERATIVE AI

(71) Applicant: L'Oreal, Paris (FR)

(72) Inventor: Edgard MAUCOURANT, Toronto (CA)

(73) Assignee: L'Oreal, Paris (FR)

(21) Appl. No.: 19/429,953

(22) Filed: Dec. 22, 2025

Related U.S. Application Data
(60) Provisional application No. 63/739,412, filed on Dec. 27, 2024.

(30) Foreign Application Priority Data
Mar. 7, 2025 (FR) FR2502293

(51) Int. Cl. A45D 44/00; G06N 3/0475; G06Q 30/0601; G06T 7/13

(52) U.S. Cl. CPC A45D 44/005; G06N 3/0475; G06Q 30/0631; G06Q 30/06431; G06T 7/13; G06T 2207/20084; G06T 2207/30201

(57) ABSTRACT

In embodiments, computer systems and methods provide a hairstyle VTO experience. A generative artificial intelligence (Gen AI) model (e.g. a diffusion-based model and a conditioning network) configured to generate output images in response to spatial conditioning is invoked with a plurality of conditioning images to condition the generation of the new hairstyle on an image of the face. The conditioning images comprise a hairstyle mask to control a shape of the new hairstyle; and an edge detection result image to guide a structure of the new hairstyle. The hairstyle mask and edge detection result are obtained from a 3D model of a sample hairstyle. The mask is aligned with a pose of the face, for example, determined from a face mesh generated for the face. The image of the face is preprocessed to remove an existing hairstyle (e.g. using a dilated hair mask and inpainting).

### CROSS-REFERENCES TO RELATED APPLICATIONS

This application claims the benefit of U.S. Provisional Application No. 63/739,412 filed Dec. 27, 2024, the entire contents of which are incorporated herein by reference. This application also claims priority to FR 2502293, filed Mar. 7, 2025, the entire contents of which are incorporated herein by reference.

### FIELD OF THE DISCLOSURE

The present disclosure relates to computer image or graphics processing, compute vision and artificial intelligence (AI)-based computer image generation, and more particularly to methods and systems for hair virtual try-ons (VTOs) using Generative (Gen) AI.

### BACKGROUND OF THE DISCLOSUER

Various generative artificial intelligence-based models exist that are trained to provide an output image having one or more traits that appear in the output image. A trait can include a preservation of an identity of a subject from an input image. A trait can be changed relative to the input image such as added to, subtracted from or modified within the input image. A trait may be a facial appliance such as glasses (e.g. to be added or removed) or a characteristic of the subject such as age (to be modified), gender (to be modified), or a hair or makeup effect (to be added).

Gen AI is useful to provide computer-based VTO user experiences where an image of a user is modified by applying an effect (e.g. a trait) to the image. One such effect is a hair effect such as a new hairstyle. However, more precise control of Gen AI models is challenging when specific effects are desired to be simulated. Gen AI models may not provide sufficiently photorealistic images and/or may not adequately simulate a desired trait such as a specific new hairstyle (including new hair coloring) that is to be applied to an input image of a user.

An objective herein is to give a user the ability to try a hairstyle virtually. The VTO experience can enable the user to make an educated decision before executing the new hairstyle, even before going to a hair salon.

### SUMMARY OF THE DISCLOSURE

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In embodiments, computer systems and methods provide a hairstyle VTO experience. A generative artificial intelligence (Gen AI) model (e.g. a diffusion-based model and a conditioning network) configured to generate output images in response to spatial conditioning is invoked with a plurality of conditioning images to condition the generation of the new hairstyle on an image of the face. The conditioning images comprise a hairstyle mask to control a shape of the new hairstyle; and an edge detection result image to guide a structure of the new hairstyle. The hairstyle mask and edge detection result are obtained from a 3D model of a sample hairstyle. The mask is aligned with a pose of the face, for example, determined from a face mesh generated for the face. The image of the face is pre-processed to remove an existing hairstyle (e.g. using a dilated hair mask and inpainting).

Statement 1: In accordance with an aspect, there is provided a computing system comprising one or more processors and one or more storage devices storing instructions executable by the one or more processors to cause the computing system to: invoke a generative artificial intelligence (Gen AI) model to obtain an output image comprising a new hairstyle on a face, the Gen AI model configured to generate output images in response to spatial conditioning, wherein to invoke comprises providing to the Gen AI model an image of the face, and a plurality of conditioning images to condition the generation of the new hairstyle, the conditioning images comprising: a hairstyle mask to control a shape of the new hairstyle; and an edge detection result image to guide a structure of the new hairstyle; and present the output image to provide a hairstyle virtual try on (VTO) experience.

Statement 2: In accordance with Statement 1: the Gen AI model comprises a diffusion-based model and a conditioning network to condition generation of the output images by the diffusion-based model.

Statement 3: In accordance with any of Statements 1-2, to invoke includes providing a text-based prompt to the Gen AI model to control the generation of the new hairstyle.

Statement 4: In accordance with any of Statements 1-3, the instructions are executable by the one or more processors to cause the computing system to process an input image to obtain the image of the face, wherein to process the input image comprises removing an existing hairstyle and inpainting a background responsive to the removing of the existing hairstyle.

Statement 5: In accordance with Statement 4, to process the input image comprises: using a deep neural network configured for hair segmentation to obtain a hair mask for the existing hairstyle; and using a Gen AI technique, responsive to the hair mask to perform the inpainting.

Statement 6: In accordance with any of Statements 1-5, the instructions are executable by the one or more processors to cause the computing system to define the hairstyle mask image and edge detection result image from a three-dimensional (3D) model of a sample hairstyle.

Statement 7: In accordance with Statement 6, wherein the instructions are executable by the one or more processors to cause the computing system to align a pose of the 3D model of the sample hairstyle to a face pose of the face and define the hairstyle mask responsive to the pose of the 3D model as aligned.

Statement 8: In accordance with Statements 7, the instructions are executable by the one or more processors to cause the computing system to obtain the edge detection result image by processing using an edge detector an image of the sample hairstyle from the 3D model as aligned.

Statement 9: In accordance with any of Statements 1-8, the instructions are executable by the one or more processors to cause the computing system to: provide a data store storing a plurality of sample hairstyles or a plurality of sample hairstyles and hair colors; and provide a VTO interface configured to display hairstyle options from the plurality of sample hairstyles and/or hair colors and to receive one or more inputs to select the sample hairstyle for the VTO experience.

Statement 10: In accordance with any of Statements 1-9, the instructions are executable by the one or more processors to cause the computing system to provide one or more interfaces to: recommend a hair product; recommend a hair salon; or purchase a hair product via an e-commerce transaction.

Statement 11: A computer-implemented method for providing a hairstyle virtual try on (VTO) experience comprising: invoking a generative artificial intelligence (Gen AI) model to obtain an output image comprising a new hairstyle on a face, the Gen AI model configured to generate output images in response to spatial conditioning, wherein the invoking comprises providing to the Gen AI model an image of the face, and a plurality of conditioning images to condition the generation of the new hairstyle, the conditioning images comprising: a hairstyle mask to control a shape of the new hairstyle; and an edge detection result image to guide a structure of the new hairstyle; and presenting the output image to provide the VTO experience.

These and other aspects will be apparent to one of skill in the art including method aspects corresponding to any computing system aspect and vice versa, or computer program product aspects corresponding to any computing system and/or method aspect.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a computing system for practicing one or more aspects in accordance with an embodiment.

FIG. 2 shows examples of data generated in, used in or resulting from the processing of the computing system of FIG. 1 in accordance with an embodiment.

FIG. 3 is tabular display 300 showing before and after image for three representative hairstyles, where the after images are generated in accordance with an embodiment herein.

FIG. 4 is a block diagram of a computing system for practicing one or more aspects in accordance with an embodiment.

FIGS. 5A-5E are block diagrams of operations 500, 506, 508, 514 and 520 in accordance with embodiments herein.

### DETAILED DESCRIPTION

The present disclosure provides methods and systems (e.g. apparatus) for hair VTOs using novel approaches to Gen AI, computer graphics and computer vision. While traditional Hair VTO techniques exist, in accordance with embodiments, the Gen AI approach herein enhances realism in challenging scenarios (e.g., black to blonde transitions) and supports features like haircuts that traditional methods can't handle or handle poorly. Unlike other AI-based hair simulations that leave results to the AI's discretion and can lead to unexpected results, the proposed methods and systems herein tightly control the outcome to match the desired hairstyle.

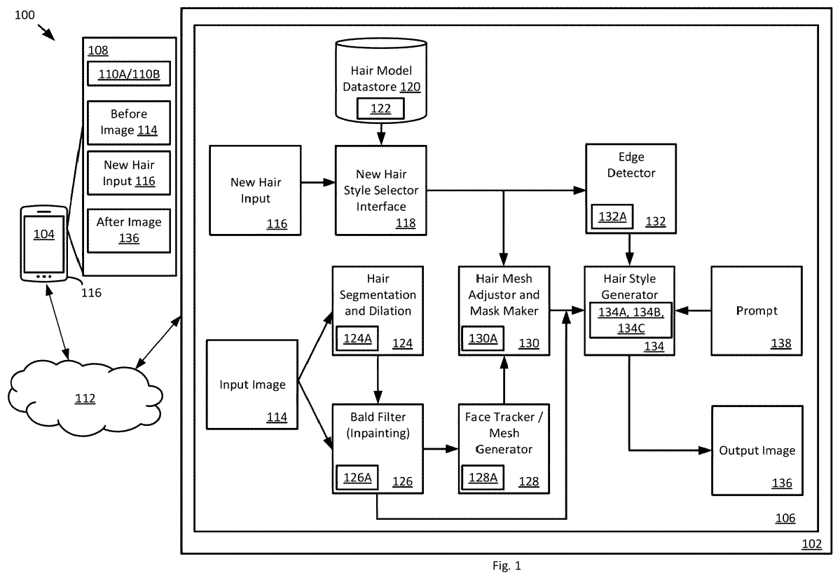

FIG. 1 is a block diagram of a computing system 100 in accordance with an embodiment. In an embodiment, a computing system herein comprises one or more computing device devices (e.g. 102, 104) each having one or more processors (not shown) and one or more storage devices (e.g. 106, 108) such as memory or other storage devices that store computer executable instructions (see various components as described further) for execution by the one or more processors to cause the respective computing device to perform a method aspect in accordance with an embodiment herein.

In an embodiment, system 100 is implemented using one or more computing devices 102, 104 and these computing devices may comprise a computing device 104 in the form of a smartphone, tablet, laptop, desktop, set top box, etc. and one or more servers 102 or other computing form factors providing web or cloud-based services.

FIG. 1 shows an example client/server paradigm, where the Gen AI-based VTO user experience is provided as a service via server 102 to computing device 104. Computing device 104 obtains the services via a web-based application 110A (e.g. executing within a browser (not shown) or via a native application 110B, each of which applications 110A/110B is configured to communicate via network 112 to server 102. Network 112 comprises one or more private or public networks, whether wired or wireless and can include the Internet.

FIG. 1 shows computing device 104 having a before image 114, such as a selfie image, captured via a camera 116 of device 104. Image 114 is provided (e.g. communicated over network 112) to server 102 as an input image 114 for processing to simulate a new hairstyle. In an embodiment, the input image 114 comprises a face, existing hairstyle and a background. Computing device 104 is enabled via application 110A/110B to select a sample hairstyle for the new hairstyle to be simulated though generation using the Gen AI model, such as via a user interface (not shown) in which images of a plurality of sample hairstyles (not shown) are provided. The user interface is enabled to receive one or more user inputs (e.g. new hair input 116) to select a style and a color. In an embodiment, the sample hairstyles (options and images) are provided to computing device 104 via a new hairstyle selector interface 118 of server 102. Interface 118 receives the input 116 and selects from a hair model datastore 120 a corresponding model of the sample hairstyle. In an embodiment, datastore 120 stores respective data sets where each set describes a hairstyle in three dimensions (3D). In an embodiment, the respective data sets 122 comprise respective hair meshes, a digital surface model comprising faces, edges and vertices, to digitally represent the hair in 3D. The input 116 is used to select a hair mesh for the user's desired hairstyle to virtually try on image 114.

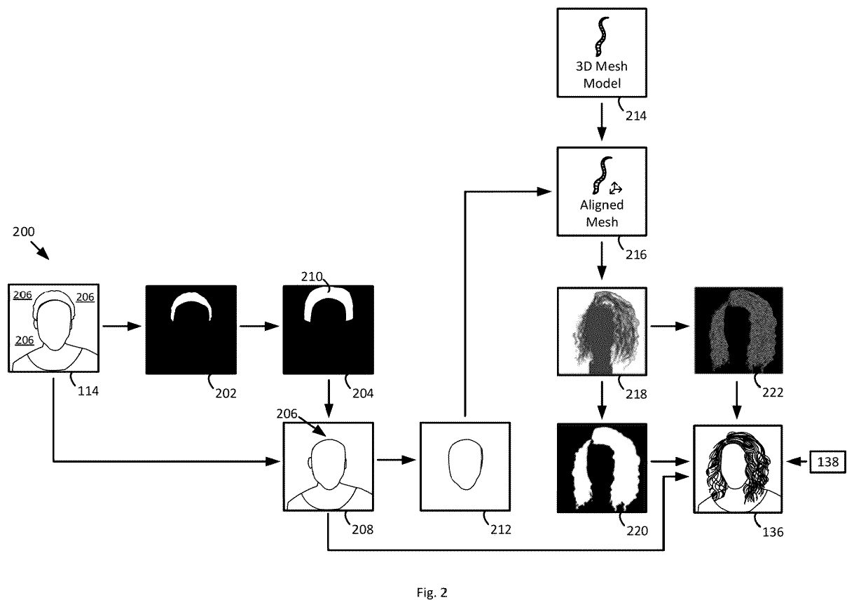

FIG. 2 illustrates examples 200 of data, set out in a representative processing workflow, where the examples 200 are used in, generated by, or otherwise resulting from the processing of computing system 100. With reference to FIGS. 1 and 2, and in accordance with an embodiment, server 102 processes input image 114 using a hair segmentation and dilation block 124 to detect and generate a hair mask 202, a form of segmentation mask, of the user's hair position in image 114. In accordance with an embodiment, hair segmentation and dilation block 124 processes image 114 using a hair segmentation model 124A to generate hair mask 202. Hair mask 202 is (further) processed to provide a dilated mask 204, enlarging the hair portion adjacent to a region of the background 206 of image 114 to generate dilated mask 206. In an embodiment, server 102 uses an interface such as an application programming interface (API) to communicate with another device (not shown) to access the model 124A and does not store and/or execute the model per se on server 102.

Dilated mask 204 and input image 114 are provided to bald filter block 126 to remove the (original) hair from input image 114. In an embodiment, block 126 uses a first generative AI structure 126A to create a bald image 208 of the user in image 114. In an embodiment, first generative AI structure 126A performs inpainting to extend background 206 into the region of image 114 where the hair was formerly present as denoted by the hair portion 210 as dilated of mask 206. In an embodiment, first Gen AI structure 126A comprises a diffusion model configured for inpainting (e.g. Stable Diffusion model for inpainting, from Stability AI). In an embodiment, server 102 uses an interface such as an API to communicate with another device (not shown) to access first Gen AI structure 126A and does not store and/or execute the structure or its model(s) per se on server 102.

Bald image 208 is processed by a face mesh generator block 128 using a face tracker 128A to determine the head's 3D position and rotation. In an embodiment, face tracker 128A comprises one or more trained machine learning models (e.g. a face mesh model) (all not shown) configured to output a 3D model of the face, namely, face mesh 214. In an embodiment, face tracker 128A comprises the MediaPipe Face Landmarker from Google AI, a division of Google LLC. In an embodiment, face tracker 128A comprises a neural network-based tracker such as described in Applicant's U.S. Pat. No. 11,227,145B2, issued 2022 Jan. 18 and entitled, “CONVOLUTION NEURAL NETWORK BASED LANDMARK TRACKER”, the contents of which are incorporated herein by reference. In an embodiment, server 102 uses an interface such as an API to communicate with another device (not shown) to access the face tracker 128A (and its model(s)) and does not store and/or execute the face tracker per se on server 102.

A hair mesh adjustor and mask block 130 aligns a sample hairstyle mesh 214 to obtain an aligned mesh 216. In an embodiment, sample 3D hair mesh 214 is previously selected from datastore 120 responsive to input 116. Sample 3D hair mesh 214 is aligned (e.g. moved or manipulated in 3D space) with a position and rotation/orientation (e.g. a “pose”) of the user's head in response to face mesh 212.

A two-dimensional (2D) rendering 218 of the aligned 3D hair mesh 216 is produced. In an embodiment, the 2D rendering 218 is used to define a new hair segmentation mask 220 for a final hair shape of the sample hairstyle on the user. In an embodiment, a segmentation model 130A generates the segmentation mask 220. In an embodiment, server 102 uses an interface such as an API to communicate with another device (not shown) to access the segmentation model 130A and does not store and/or execute the model per se on server 102.

In an embodiment, the 2D rendering 218 is processed by edge detector block 132 to provide an edge detected image 222 to guide a Gen AI model, in a controlled manner, to generate the new hairstyle. In an embodiment, edge detector block 132 is configured with or is otherwise configured to use an edge detector function 132A. In an embodiment the function is configured to implement Canny edge detection. An example is available from OpenCV, an open-source computer vision library. The resulting edge detected image 222 further refines the hair strand positioning for consistency using the Gen AI model. Edge detection approaches other than Canny edge detection can be used.

A hairstyle generator block 134 uses a second Gen AI structure 134A to obtain output image 136. In an embodiment, server 102 uses an interface such as an API to communicate with another device (not shown) to access the second Gen AI structure 134A and does not store and/or execute the model per se on server 102. In an embodiment, output image 136 is communicated to computing device 104 for use as after image 136. In an embodiment, device 104 displays the after image 136 (not shown). The image 136 may be stored, shared, etc.

In an embodiment, second Gen AI structure 134A comprises a diffusion-based model (134B shown), and a conditioning neural network (134C) in combination that controls image generation by the diffusion-based model by adding extra (e.g. spatial) conditions. In an embodiment, the diffusion-based model comprises a text-to-image diffusion model. An example is Stable Diffusion from Stable AI. In an example, the controlling neural network comprises ControlNet such as described by Zhang et al. in “Adding Conditional Control to Text-to-Image Diffusion Models”, arXiv:2302.0553v3, 26 Nov. 2023, incorporated herein by reference) trained to provide conditions to the diffusion model. Accordingly with the embodiment, the U-Net architecture of Stable Diffusion is connected with a ControlNet on respective encoder blocks and middle block. These blocks of Stable Diffusion are locked and the encoder blocks and middle block of the ControlNet are trainable. Zero convolution layers are added to the ControlNet and connected to Stable Diffusion's decoder blocks to guide the generation of output. In an embodiment, the ControlNet employs Low-Rank Adaptation (LoRA) techniques for adaptation of a pre-trained diffusion model such as Stabile Diffusion. LoRA techniques are described in Hu, Edward J., et al. “Lora: Low-rank adaptation of large language models.” arXiv preprint arXiv:2106.09685 (2021) and as updated (arXiv:2106.09685v2, 16 Oct. 2022). LoRA techniques employ re-parameterization to fine tune certain parameters while maintaining (“freezing”) the pre-trained model, significantly reducing resource consumption. LoRA “train[s] some dense layers in a neural network indirectly by optimizing rank decomposition matrices of the dense layers'change during adaptation instead, while keeping the pre-trained weights frozen” (ibid, p.2).

In an embodiment, hairstyle generator block 134 communicates to second Gen AI structure 134A a plurality of inputs for the desired task, namely generating an output image with the new hairstyle. In an embodiment, hairstyle generator block 134 provides bald image 208, segmentation mask 220, edge detected image 222, and a prompt 138 to second Gen AI model 134A to produce output image 136. In an embodiment, prompt 138 comprises a text-based prompt in a natural language. Bald image 208 provides a base upon which to generate new content. The new content is spatially guided by the hair segmentation mask 220 and the edge detected image 222 giving refined spatial controls to the text-to-image model via the controlling neural network.

In an embodiment, the text-based prompt comprises a regular prompt for Stable Diffusion such as “A portrait of {keyword} in a business pose looking straight at the camera, with a black top and a white background” where {keyword} is the specific keyword used to trigger the LoRA network during the inference time.

FIG. 3 is tabular display 300 showing before images (e.g. 302) and after images 304 for three representative hairstyles (306), where the after images 304 are generated in accordance with an embodiment herein.

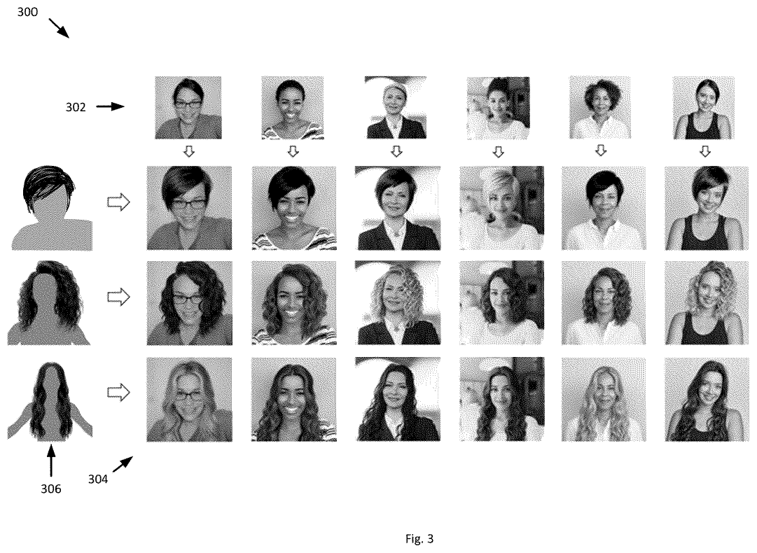

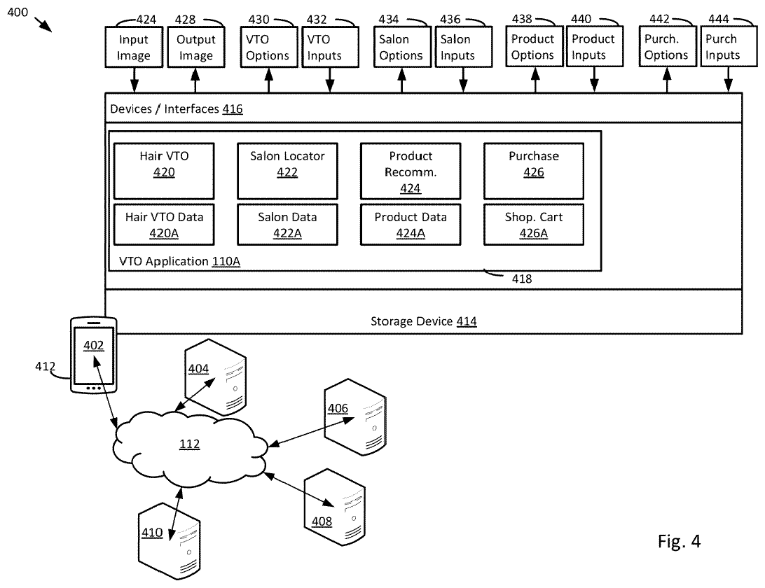

FIG. 4 is a block diagram of a computing system 400 for practicing one or more aspects in accordance with an embodiment. Computing system 400 includes a computing (e.g. user) device 402, a VTO server 404, a salon locator server 406, a product server 408 and an e-commerce server 410. Computing device 402 is coupled for communication via a network 112 with the servers 404-410. Computing device 402 is configured similarly to device 104 having one or more processors 412, one or more storage devices 414, one or more input, output and/or input/output devices/interfaces 416, including a display screen, a camera, and location/positioning device (not shown separately).

Computing device 402 implements a VTO application 110A as a browser-based application executing in a browser 418, which is shown for simplicity including various components and associated data for application 110A. Components and data of VTO application 110A comprises hair VTO block 420, hair VTO data 420a, salon locator block 422, salon data 422A, product recommendation block 424 and product data 424A, purchase block 426 and shopping cart 426A comprising purchase related data.

VTO server 404 implements services to provide a hair VTO, for example, operating similarly to one or more embodiments describe with reference to server 102. Though the servers 404-410 are shown separately, the services each provides may be combined such as to provide product and salon locator services together over fewer physical servers. In an embodiment, an input image 424 is provided, such through a camera or other manner, and an output image 428 is provided in which a new hairstyle is generated in accordance with the teaching herein. Output image 428 may be displayed via computing device 402. In an embodiment, hair VTO block 420 presents VTO options 430 such as hairs styles and colors etc. via a user interface to the user. In an embodiment, the user makes VTO inputs 432 selecting at least one option for a hair VTO relative to input image 424. For example, the user taps an option on a screen of a touch screen-based input/output interface.

Salon locator server 406 is configured to provide locations of salons. In an embodiment, salon location is responsive to a physical location of computing device 402, for example, showing salons within a radius thereof. In an embodiment, salon options 434 are presented via a user interface (e.g. 416). In an embodiment, a user's location is responsive to user input such as salon input 436 or salon input 436 selects a salon location such as for more information or to make a message or call to make an inquiry and/or a booking (not shown).

Product server 408 is configured to provide product information such as images of products such as hair color and or care products and descriptions therefor. The product data, in an embodiment, is presented (e.g. displayed) via an interface 416 such as product options 438. User product input 440 is received, in an embodiment, to for more information or to initiate a purchase (not shown).

E-commerce server 410 is configured for completing an e-commerce transaction, for example, to purchase one or more products. Purchase options 442 are provided via interface 416 and purchase inputs 444 (e.g. from a user) are received for an e-commerce transaction.

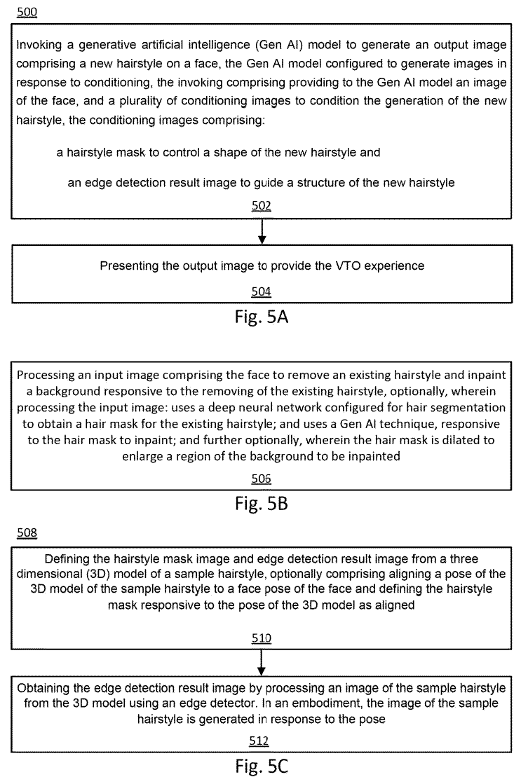

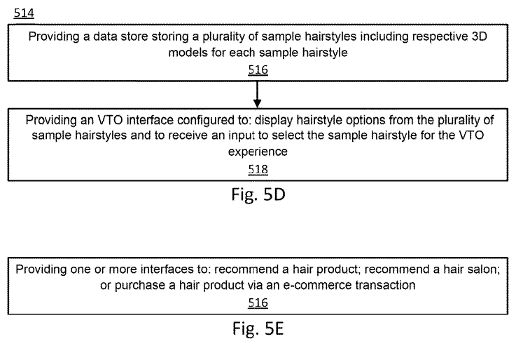

FIGS. 5A-5E are block diagrams of operations 500, 506, 508, 514 and 520 in accordance with embodiments herein. In an embodiment, operations 500 implement a method for providing a hairstyle virtual try on (VTO) experience. At 502, operations invoke a generative artificial intelligence (Gen AI) model to obtain an output image comprising a new hairstyle on a face, the Gen AI model configured to generate output images in response to spatial conditioning, wherein the invoking comprises providing to the Gen AI model an image of the face, and a plurality of conditioning images to condition the generation of the new hairstyle, the conditioning images comprising: a hairstyle mask to control a shape of the new hairstyle; and an edge detection result image to guide a structure of the new hairstyle. To invoke comprises requesting a component to perform operations it is configured to perform and can include utilizing an application programming interface (API), utilizing a user interface control, etc. to make the request. At 504, operations present the output image to provide the VTO experience. In an embodiment, the Gen AI model comprises a diffusion-based model and a conditioning neural network to condition generation of the output images by the diffusion-based model. In an embodiment, the diffusion-based model comprises Stabile Diffusion and the conditioning neural network comprises ControlNet. In an embodiment, the invoking includes providing a text-based prompt to the Gen AI model to control the generation of the new hairstyle.

With reference to FIG. 5B, operations 506 process an input image to obtain the image of the face. In an embodiment, the processing of the image comprises removing an existing hairstyle and inpainting a background responsive to the removing of the existing hairstyle. Optionally, in an embodiment, the processing the input image comprises: using a deep neural network configured for hair segmentation to obtain a hair mask for the existing hairstyle; and using a Gen AI technique, responsive to the hair mask to inpaint. In an embodiment, the Gen AI technique uses the Stabile Diffusion model (an ControlNet) to inpaint. In an embodiment, further optionally, the hair mask is dilated to enlarge a region of the background to be inpainted.

With reference to FIG. 5C, operations 508 are shown for processing a 3D model of a sample hairstyle in accordance with an embodiment to define spatial conditioning image for the Gen AI model. At 510, operations define the hairstyle mask image and edge detection result image from a three-dimensional (3D) model of a sample hairstyle, optionally comprising aligning a pose of the 3D model of the sample hairstyle to a face pose of the face; and defining the hairstyle mask responsive to the pose of the 3D model as aligned (e.g. using a 2D rendering of the aligned model to determine the mask). At 512, operations obtain the edge detection result image using an edge detector that processes the 2D rendering of the sample hairstyle from the aligned 3D model. In an embodiment, the image of the sample hairstyle is generated in response to the pose. In an embodiment, a face mesh is constructed of the face and the pose of the 3D model of the sample is aligned with the face pose of the face mesh.

With reference to FIG. 5D, operations 514 are shown for a VTO interface. At 516, operations provide a data store storing a plurality of sample hairstyles including respective 3D models for each sample hairstyle. At 518, operations providing an VTO interface configured to display hairstyle options from the plurality of sample hairstyles and to receive an input to select the sample hairstyle for the VTO experience. Optionally, the VTO interface is configured to present a plurality of hair colors and to receive an input selecting a sample hair color for the sample hairstyle for the VTO experience. In embodiments inputs are received to select the sample hairstyle and a sample hair color. In embodiments a particular sample hairstyle is shown in respective colors for selecting the sample to also select the color at the same time. In an embodiment, the input image is processed to determine hair color and a closest matching hair color from a plurality of stored hair colors is provided as an option to select or is used (e.g. as a default).

With reference to FIG. 5E, operations 520 provide one or more interfaces to: recommend a hair product; recommend a hair salon; or purchase a hair product via an e-commerce transaction.

Practical implementation may include any or all of the features described herein. These and other aspects, features and various combinations may be expressed as methods, apparatus, systems, means for performing functions, program products, and in other ways, combining the features de-scribed herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or re-moved from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, un-less the context requires otherwise. By way of example and without limitation, references to a computing device comprising a processor and/or a storage device includes a computing device having multiple processors and/or multiple storage devices. Herein, “A and/or B” means A or B or both A and B.

Features, integers characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

It will be understood that corresponding computer implemented method aspects and/or computer program product aspects are also disclosed. A computer program product, for example, comprises a storage device storing computer readable instructions that when executed by at least one processor of a computing device causes the computing device to perform operations of a computer implemented method.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computing system comprising one or more processors and one or more storage devices storing instructions executable by the one or more processors to cause the computing system to:
invoke a generative artificial intelligence (Gen AI) model to obtain an output image comprising a new hairstyle on a face, the Gen AI model configured to generate output images in response to spatial conditioning, wherein to invoke comprises providing to the Gen AI model an image of the face, and a plurality of conditioning images to condition the generation of the new hairstyle, the conditioning images comprising:
a hairstyle mask to control a shape of the new hairstyle; and
an edge detection result image to guide a structure of the new hairstyle; and present the output image to provide a hairstyle virtual try on (VTO) experience.

2. The computing system of claim 1, wherein the Gen AI model comprises a diffusion-based model and a conditioning neural network to condition generation of the output images by the diffusion-based model.

3. The computing system of claim 1, wherein to invoke includes providing a text-based prompt to the Gen AI model to control the generation of the new hairstyle.

4. The computing system of claim 1, wherein the instructions are executable by the one or more processors to cause the computing system to process an input image to obtain the image of the face, wherein to process the input image comprises removing an existing hairstyle and inpainting a background responsive to the removing of the existing hairstyle.

5. The computing system of claim 4, wherein to process the input image comprises: using a deep neural network configured for hair segmentation to obtain a hair mask for the existing hairstyle; and using a Gen AI technique, responsive to the hair mask to perform the inpainting.

6. The computing system of claim 1, wherein the instructions are executable by the one or more processors to cause the computing system to define the hairstyle mask image and edge detection result image from a three-dimensional (3D) model of a sample hairstyle.

7. The computing system of claim 6, wherein the instructions are executable by the one or more processors to cause the computing system to align a pose of the 3D model of the sample hairstyle to a face pose of the face and define the hairstyle mask responsive to the pose of the 3D model as aligned.

8. The computing system of claim 7, wherein the instructions are executable by the one or more processors to cause the computing system to obtain the edge detection result image by processing, using an edge detector, an image of the sample hairstyle from the 3D model as aligned.

9. The computing system of claim 1, wherein the instructions are executable by the one or more processors to cause the computing system to: provide a data store storing a plurality of sample hairstyles or a plurality of sample hairstyles and hair colors; and provide a VTO interface configured to display hairstyle options from the plurality of sample hairstyles and/or hair colors and to receive one or more inputs to select the sample hairstyle for the VTO experience.

10. The computing system of claim 1, wherein the instructions are executable by the one or more processors to cause the computing system to provide one or more interfaces to: recommend a hair product; recommend a hair salon; or purchase a hair product via an e-commerce transaction.

11. A computer-implemented method for providing a hairstyle virtual try on (VTO) experience comprising:
invoking a generative artificial intelligence (Gen AI) model to obtain an output image comprising a new hairstyle on a face, the Gen AI model configured to generate output images in response to spatial conditioning, wherein the invoking comprises providing to the Gen AI model an image of the face, and a plurality of conditioning images to condition the generation of the new hairstyle, the conditioning images comprising:
a hairstyle mask to control a shape of the new hairstyle; and an edge detection result image to guide a structure of the new hairstyle; and presenting the output image to provide the VTO experience.

12. The method of claim 11, wherein the Gen AI model comprises a diffusion-based model and a conditioning neural network to condition generation of the output images by the diffusion-based model.

13. The method of claim 11, wherein the invoking includes providing a text-based prompt to the Gen AI model to control the generation of the new hairstyle.

14. The method of claim 11 comprising processing an input image to obtain the image of the face, the processing comprising removing an existing hairstyle and inpainting a background responsive to the removing of the existing hairstyle.

15. The method of claim 14, wherein the processing the input image comprises: using a deep neural network configured for hair segmentation to obtain a hair mask for the existing hairstyle; and using a Gen AI technique, responsive to the hair mask to perform the inpainting.

16. The method of claim 11 comprising defining the hairstyle mask image and edge detection result image from a three-dimensional (3D) model of a sample hairstyle.

17. The method of claim 16 comprising aligning a pose of the 3D model of the sample hairstyle to a face pose of the face and defining the hairstyle mask image and edge detection result image responsive to the pose of the 3D model as aligned.

18. The method of claim 17 comprising defining the hairstyle mask image and edge detection result image by processing a two-dimensional image of the sample hairstyle from the 3D model.

19. The method of claim 11 comprising: providing a data store storing a plurality of sample hairstyles or a plurality of sample hairstyles and hair colors; and providing a VTO interface configured to display hairstyle options from the plurality of sample hairstyles and/or hair colors and to receive one or more inputs to select the sample hairstyle for the VTO experience.

20. The method of claim 11 comprising providing one or more interfaces to: recommend a hair product; recommend a hair salon; or purchase a hair product via an e-commerce transaction.
